(19) United States
(12) Patent Application Publication
(10) Pub. No.: US 2025/0365096 A1
(43) Pub. Date: Nov. 27, 2025

(54) MANAGING ACKNOWLEDGMENT (ACK) TO NEGATIVE ACK (A2N) ERRORS

(71) Applicant: QUALCOMM Incorporated, San Diego, CA (US)

(72) Inventors: Mostafa KHOSHNEVISAN, San Diego, CA (US); Sitaramanjaneyulu KANAMARLAPUDI, San Diego, CA (US); Jing SUN, San Diego, CA (US)

(21) Appl. No.: 18/672,810

(22) Filed: May 23, 2024

(51) Int. Cl. H04L 1/1607; H04L 1/08

(52) U.S. Cl. CPC H04L 1/1692; H04L 1/08

(57) ABSTRACT

Aspects of the disclosure are directed to a wireless node configured to detect and respond to acknowledgement-to-negative acknowledgement (A2N) events. In some examples, the wireless node is configured to output a first control signal configured to acknowledge that a first data signal has been obtained, wherein the first control signal is output for transmission at a first transmit power. In some examples, the wireless node is configured to obtain, after outputting the first control signal, first signaling indicative of retransmission of the first data signal and further indicative of a first acknowledgment to negative acknowledgment (A2N) event. In some examples, the wireless node is configured to, after obtaining the first signaling, output corrective signaling indicative of the first A2N event.

### BACKGROUND

### Technical Field

The present disclosure generally relates to communication systems, and more particularly, to managing acknowledgment (ACK) to negative ACK (A2N) errors.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

Aspects of the disclosure are directed to an apparatus for wireless communication. In some examples, the apparatus includes one or more memories, individually or in combination, having instructions, and one or more processors, individually or in combination, configured to execute the instructions. In some examples, the one or more processors, individually or in combination, are configured to output a first control signal configured to acknowledge that a first data signal was obtained, wherein the first control signal is output for transmission at a first transmit power. In some examples, the one or more processors, individually or in combination, are configured to obtain, after outputting the first control signal, first signaling indicative of retransmission of the first data signal and further indicative of a first acknowledgment to negative acknowledgment (A2N) event. In some examples, the one or more processors, individually or in combination, are configured to after obtaining the first signaling, output corrective signaling comprising at least one of: (i) a second control signal, wherein the second control signal is output for transmission at a second transmit power greater than the first transmit power based at least in part on the first A2N event, or (ii) a report indicative of the first A2N event.

Aspects of the disclosure are directed to an apparatus for wireless communication. In some examples, the apparatus includes one or more memories, individually or in combination, having instructions, and one or more processors, individually or in combination, configured to execute the instructions. In some examples, the one or more processors, individually or in combination, are configured to output a first data signal. In some examples, the one or more processors, individually or in combination, are configured to output first signaling indicative of a retransmission of the first data signal, wherein the first signaling is output after not obtaining, during a time window, an acknowledgment of receipt of the first data signal. In some examples, the one or more processors, individually or in combination, are configured to output the first data signal for retransmission. In some examples, the one or more processors, individually or in combination, are configured to obtain corrective signaling configured to indicate a first acknowledgment to negative acknowledgment (A2N) event associated with the first data signal.

Aspects of the disclosure are directed to a method for wireless communication at a wireless node. In some examples, the method includes outputting a first control signal configured to acknowledge that a first data signal was obtained, wherein the first control signal is output for transmission at a first transmit power. In some examples, the method includes obtaining, after outputting the first control signal, first signaling indicative of retransmission of the first data signal and further indicative of a first acknowledgment to negative acknowledgment (A2N) event. In some examples, the method includes, after obtaining the first signaling, outputting corrective signaling comprising at least one of: (i) a second control signal, wherein the second control signal is output for transmission at a second transmit power greater than the first transmit power based at least in part on the first A2N event, or (ii) a report indicative of the first A2N event.

Aspects of the disclosure are directed to a method for wireless communication at a wireless node. In some examples, the method includes outputting a first data signal. In some examples, the method includes outputting first signaling indicative of a retransmission of the first data signal, wherein the first signaling is output after not obtaining, during a time window, an acknowledgment of receipt of the first data signal. In some examples, the method includes outputting the first data signal for retransmission. In some examples, the method includes obtaining corrective signaling configured to indicate a first acknowledgment to negative acknowledgment (A2N) event associated with the first data signal.

Aspects of the disclosure are directed to an apparatus for wireless communication. In some examples, the apparatus includes means for outputting a first control signal configured to acknowledge that a first data signal was obtained, wherein the first control signal is output for transmission at a first transmit power. In some examples, the apparatus includes means for obtaining, after outputting the first control signal, first signaling indicative of retransmission of the first data signal and further indicative of a first acknowledgment to negative acknowledgment (A2N) event. In some examples, the apparatus includes means for, after obtaining the first signaling, outputting corrective signaling comprising at least one of: (i) a second control signal, wherein the second control signal is output for transmission at a second transmit power greater than the first transmit power based at least in part on the first A2N event, or (ii) a report indicative of the first A2N event.

Aspects of the disclosure are directed to an apparatus for wireless communication. In some examples, the apparatus includes means for outputting a first data signal. In some examples, the apparatus includes means for outputting first signaling indicative of a retransmission of the first data signal, wherein the first signaling is output after not obtaining, during a time window, an acknowledgment of receipt of the first data signal. In some examples, the apparatus includes means for outputting the first data signal for retransmission. In some examples, the apparatus includes means for obtaining corrective signaling configured to indicate a first acknowledgment to negative acknowledgment (A2N) event associated with the first data signal.

Aspects of the disclosure are directed to a non-transitory computer-readable medium comprising instructions that, when executed by a wireless node, cause the wireless node to perform a method. In some examples, the method includes outputting a first control signal configured to acknowledge that a first data signal was obtained, wherein the first control signal is output for transmission at a first transmit power. In some examples, the method includes obtaining, after outputting the first control signal, first signaling indicative of retransmission of the first data signal and further indicative of a first acknowledgment to negative acknowledgment (A2N) event. In some examples, the method includes, after obtaining the first signaling, outputting corrective signaling comprising at least one of: (i) a second control signal, wherein the second control signal is output for transmission at a second transmit power greater than the first transmit power based at least in part on the first A2N event, or (ii) a report indicative of the first A2N event.

Aspects of the disclosure are directed a non-transitory computer-readable medium comprising instructions that, when executed by a wireless node, cause the wireless node to perform a method. In some examples, the method includes outputting a first data signal. In some examples, the method includes outputting first signaling indicative of a retransmission of the first data signal, wherein the first signaling is output after not obtaining, during a time window, an acknowledgment of receipt of the first data signal. In some examples, the method includes outputting the first data signal for retransmission. In some examples, the method includes obtaining corrective signaling configured to indicate a first acknowledgment to negative acknowledgment (A2N) event associated with the first data signal.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a call-flow diagram illustrating example communications between a UE and a network entity.

FIG. 6 is a flowchart of a method of wireless communication.

FIG. 7 is another flowchart of a method of wireless communication.

FIG. 8 is a diagram illustrating an example of a hardware implementation for an example apparatus.

FIG. 9 is a flowchart of a method of wireless communication.

FIG. 10 is a diagram illustrating another example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

As described herein, an acknowledgment (ACK) is a signal that is transmitted from a first wireless node to a second wireless node, and configured to confirm that the first wireless node has successfully received a packet of data. In other words, an ACK tells the second wireless node that a signal it transmitted was successfully received, thereby allowing the second wireless node to transmit the next packet of data.

As described herein, a negative ACK (NACK) is a signal that is transmitted from the first wireless node to the second wireless node to indicate that the first wireless node has failed to successfully receive a packet of data. In some examples, the NACK is a request for the second wireless node to retransmit the packet. ACK and NACK signals may be transmitted via a control channel.

In certain aspects, due to a decoding failure, interference, pathloss, etc., an ACK transmitted by the first wireless node may be detected by the second wireless node as a NACK (e.g., an ACK to NACK (A2N) error). For example, the first wireless node may correctly receive and ACK a data packet transmitted by the second wireless node, but due to some error in transmission or decoding of the ACK, the second wireless node may interpret it as a NACK. As a result, the second wireless node may unnecessarily retransmit the data packet to the first wireless node, leading to inefficient use of resources. For example, A2N errors may increase latency due to retransmissions holding up in the buffer of the second wireless node. Moreover, A2N errors may result in unnecessary link adaptations (e.g., reduced MCS for future transmissions to achieve a target block error rate (BLER)) that may further reduce throughput.

In a similar situation, the first wireless node may transmit a NACK to the second wireless node because it did not correctly receive a data packet transmitted by the second wireless node. However, due to an error in transmission or decoding, the second wireless node may interpret the NACK as an ACK (e.g., a NACK to ACK (N2A) error). Consequently, the second wireless node may not retransmit the data packet because it assumes that the packet has been successfully received by the first wireless node. Such a scenario may cause a loss of data at the first wireless node and later data recovery communications between the wireless nodes may increase communication latency and inefficiency.

Thus, aspects of the disclosure are directed to detecting A2N and N2A errors, and performing actions to reduce such errors.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

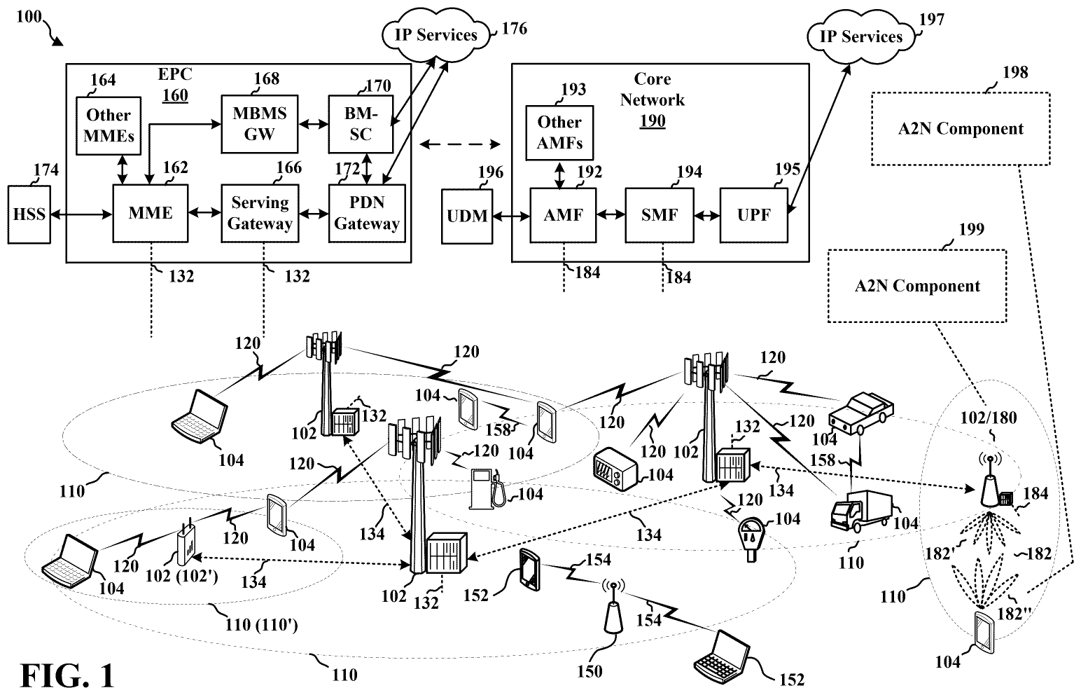

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity.

Referring again to FIG. 1, the UE 104 may include an A2N component 198. As described in more detail elsewhere herein, the A2N component 198 may be configured to output a first control signal configured to acknowledge that a first data signal was obtained, wherein the first control signal is output for transmission at a first transmit power; obtain, after outputting the first control signal, first signaling indicative of retransmission of the first data signal and further indicative of a first acknowledgment to negative acknowledgment (A2N) event; and after obtaining the first signaling, output corrective signaling comprising at least one of: (i) a second control signal, wherein the second control signal is output for transmission at a second transmit power greater than the first transmit power based at least in part on the first A2N event, or (ii) a report indicative of the first A2N event. Additionally, or alternatively, the A2N component 198 may perform one or more other operations described herein.

The base station 102/180 may include an A2N component 199. As described in more detail elsewhere herein, the A2N component 199 may be configured to output a first data signal; output first signaling indicative of a retransmission of the first data signal, wherein the first signaling is output after not obtaining, during a time window, an acknowledgment of receipt of the first data signal; output the first data signal for retransmission; and obtain corrective signaling configured to indicate a first acknowledgment to negative acknowledgment (A2N) event associated with the first data signal. Additionally, or alternatively, the A2N component 199 may perform one or more other operations described herein.

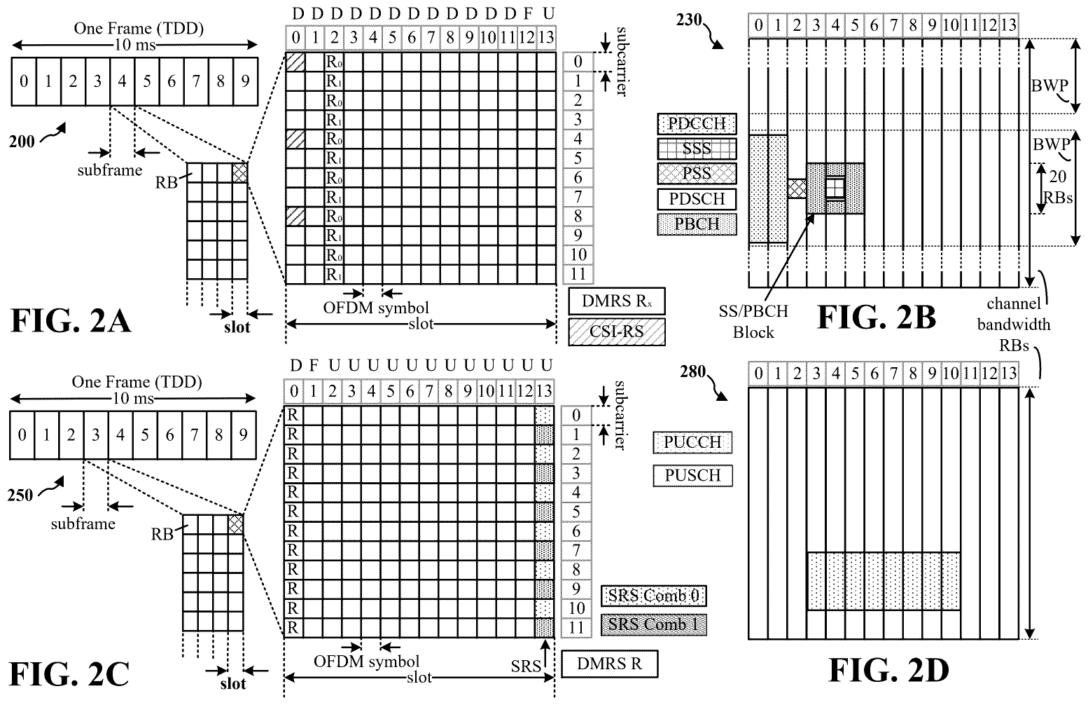

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

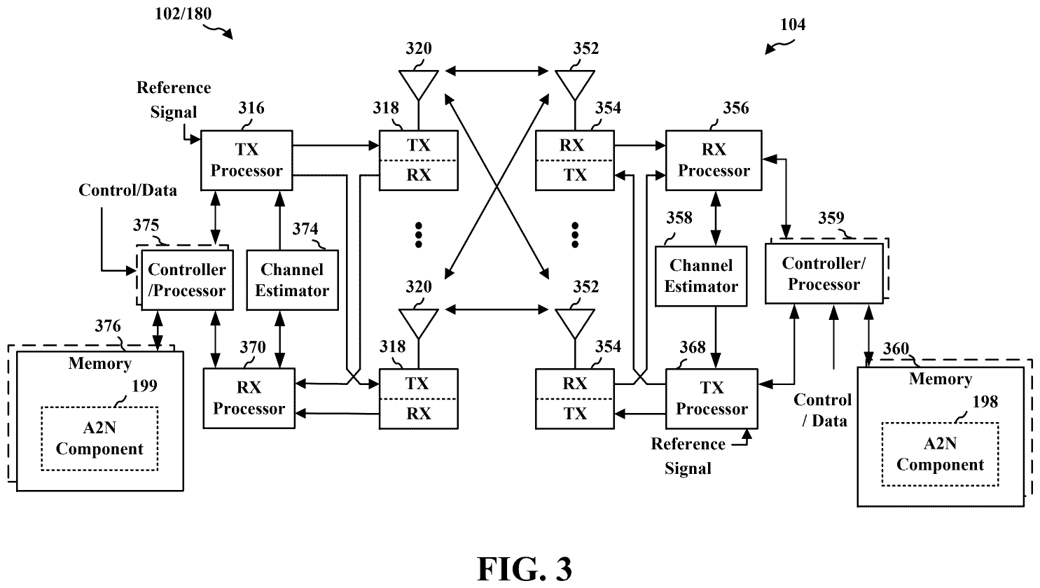

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the one or more memories 360, the TX processor 368, the RX processor 356, and the controller/processor 359 may be configured to perform aspects in connection with the A2N component 198 of FIG. 1.

At least one of the one or more memories 376, the TX processor 316, the RX processor 370, and the controller/processor 375 may be configured to perform aspects in connection with the A2N component 199 of FIG. 1.

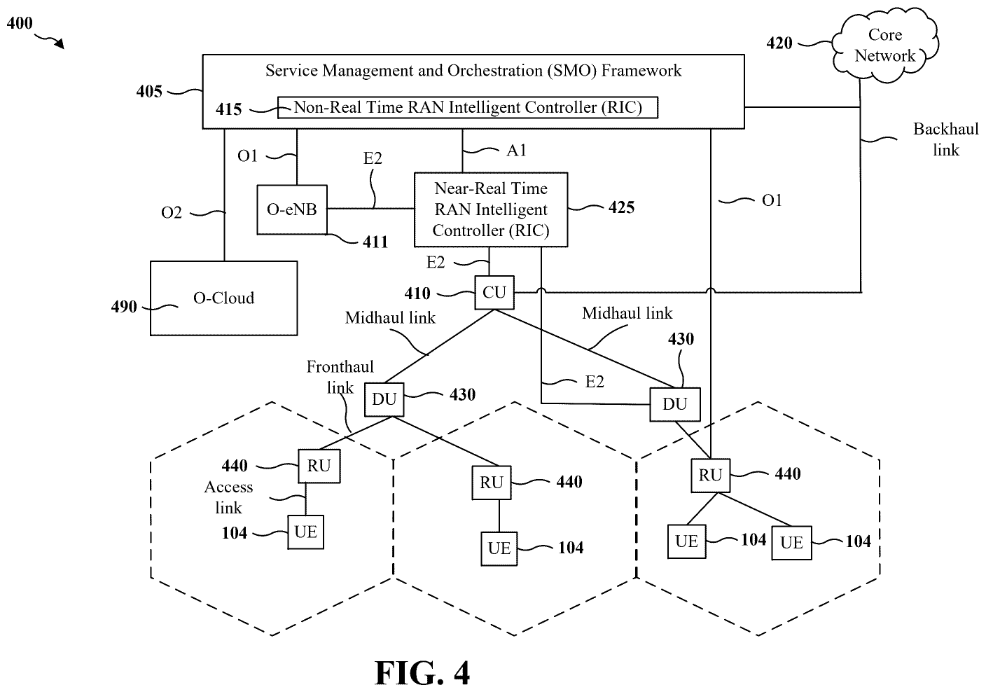

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUs 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include one or more receivers, one or more transmitters or transceivers (such as one or more radio frequency (RF) transceivers), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as A1 policies).

### Examples of UE Detection of an A2N Event

With regard to A2N (ACK-to-NACK) and N2A (NACK-to-ACK) errors, a UE may have more information, relative to a network entity, from which it can determine whether an A2N or N2A error has occurred. For example, if the UE correctly receives, decodes, and transmits HARQ feedback (e.g., ACK/NACK, UCI, PUCCH, PUSCH) for a data packet it received from the network entity, but then it subsequently receives a downlink grant (e.g., DCI) indicating a retransmission of the data packet, the UE may determine the occurrence of an A2N event associated with a HARQ feedback transmission. In this example, the UE properly transmits HARQ feedback for the data received via a transport block (TB), but the network entity schedules a retransmission of the same data of that TB by transmitting a DCI to the UE indicating the same HARQ-ID and/or same new data indicator (NDI) as the original TB that was correctly received and for which HARQ feedback was transmitted by the UE. This implies that an A2N error occurred, meaning that the HARQ feedback for the original TB was not properly received by the network entity (e.g., the network entity misinterpreted an ACK as a NACK). Moreover, when the network entity retransmits the data associated with the A2N event, the UE may discard the TB(s) carrying data that the UE has already received, decoded, and provided HARQ feedback. Thus, the UE will discard retransmitted TBs that it has previously decoded, as they are essentially duplicates.

Accordingly, the UE may determine, based on the discarded data and/or the DCI indicating the same HARQ-ID and/or same NDI, that an A2N error has occurred. In contrast, the network entity may not be capable of making the same determination because it does not have this information. Therefore, aspects of the disclosure are directed to methods and techniques that the UE may perform in response to a determined A2N event that may improve communications with the network entity, either through reactive actions and/or by reporting the A2N event to the network entity. It should be noted that in some examples, while the methods and techniques that the UE may perform are in response to a determined A2N event, the same methods and techniques may also reduce N2A events, as described below in more detail.

### Examples of UE Actions in Response to Detecting an A2N Event

As discussed above, the UE may have more information, relative to the network entity, from which it can determine whether an A2N or N2A error/event has occurred in a communication between the UE and network entity. Thus, in order to reduce such events, actions taken by the UE in response to the event may reduce or eliminate such events occurring in future communications between the UE and network entity. Such actions may include one or more of: (i) reporting the detected A2N event to the network entity, and/or (ii) increasing transmit power at the UE to increase the likelihood that an ACK/NACK is correctly received.

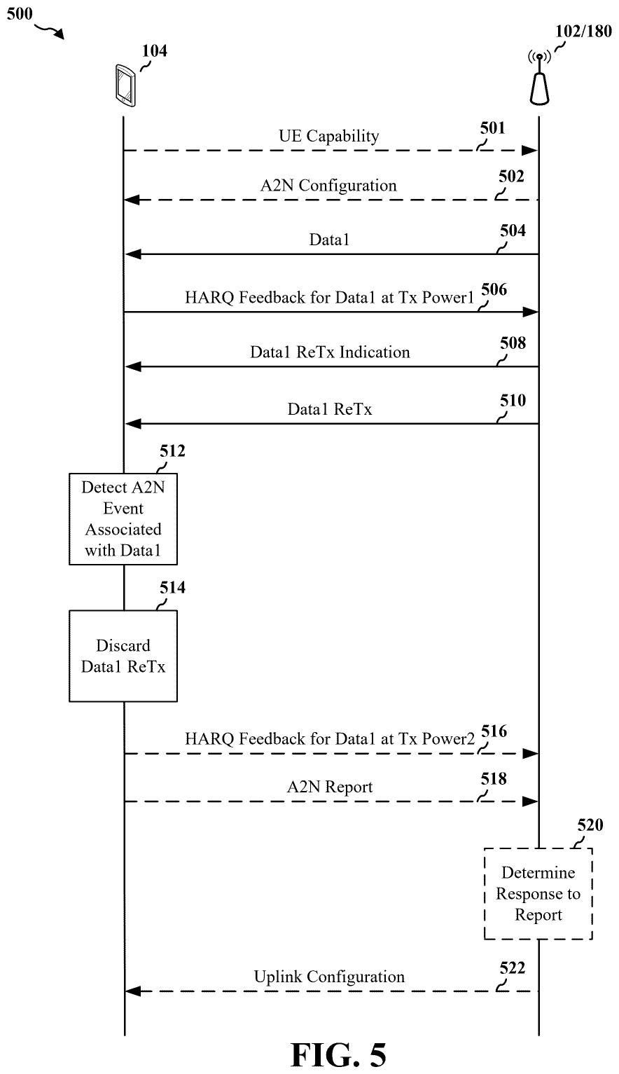

FIG. 5 is a call-flow diagram illustrating example communications 500 between a UE 104 and a network entity 102.

At an optional first communication 502, the network entity 102 may transmit an A2N configuration message for configuring the UE 104 to detect an A2N event and/or one or more actions the UE 104 may take in response to detecting the A2N event. It should be noted that in some examples, the UE 104 may be preconfigured (e.g., during production as part of a wireless standard or product design) with A2N configuration information. In such examples, a configuration message may not be necessary.

In certain aspects, the A2N configuration message may provide the UE 104 with an indication of one or more events detected by the UE 104 that qualify as A2N events for which the UE 104 may take an action. In one example, an A2N event detected by the UE 104 is a qualified event if the event includes receiving, by the UE 104 from the network entity 102, an indication of a downlink retransmission (e.g., DCI, downlink grant, etc., illustrated as a fourth communication 508) from the network entity 102. For instance, the indication of the downlink retransmission may schedule a retransmission of data (e.g., via a transport block (TB)) that was previously received, decoded, and acknowledged (ACK'd) by the UE 104. Here, the UE 104 may determine that indication of a downlink retransmission includes an NDI that is unchanged from the original transmission ACK'd by the UE 104. Thus, the UE 104 may determine that an A2N event occurred based on receiving an NDI for retransmission of data that the UE 104 has already decoded and ACK'd.

In certain aspects, the A2N configuration message may indicate that the UE 104 may detect a qualified A2N event if the UE 104 determines that data and/or a particular TB received from the network entity 102 has already been received, decoded, and ACK'd. For example, the UE 104 may discard a TB that it previously received and decoded. In this example, the TB is a redundant transmission to the UE 104 indicative of an A2N event.

In certain aspects, the A2N configuration message may indicate whether the UE 104 may perform one or more actions in response to detecting an A2N event. For example, the A2N configuration message may indicate that the UE 104 may increase uplink transmission power of HARQ feedback transmissions, and/or generate and transmit a report to the network entity to report the A2N event.

In certain aspects, the A2N configuration message may indicate one or more conditions associated with the detected A2N event to be satisfied prior to the UE to taking one or more actions. In one example, the A2N configuration message may configure the UE 104 to perform one or more actions in response to each A2N event detected. Thus, if the UE 104 detects an A2N event, the UE 104 may increase transmit power of feedback transmissions, and/or generate and transmit a report to the network entity 102 notifying the network entity of the detected A2N event.

In another example, the A2N configuration message may configure the UE 104 to perform one or more actions in response to a detected A2N event if a threshold quantity of A2N events is detected by the UE 104 within a particular time window. The A2N configuration message may indicate the duration of the time window (e.g., in terms of a number of slots, number of symbols, or any other suitable unit of time). Thus, if the UE 104 detects a number of A2N events that occur within the time window, and the number of events satisfies the threshold quantity of events, then the UE 104 may increase transmit power of feedback transmissions, and/or generate and transmit a report to the network entity 102 notifying the network entity of one or more of the A2N events.

In another example, the A2N configuration message may configure the UE 104 to perform one or more actions based on whether a particular type of A2N event satisfies a threshold condition within a particular time window. For example, the UE 104 may track a number of A2N events that are detected based on the UE 104 receiving a retransmission of data after the UE 104 receives, decodes and properly transmits HARQ feedback for a previous transmission of the same data. As used throughout the specification, this type of A2N event may be referred to as a “PUCCH error.” It should be noted that a single PUCCH error may indicate one or more A2N errors when the payload of a single PUCCH includes multiple ACKs that are incorrectly decoded as NACKs at the network entity 102. Thus, although a PUCCH error may cause the UE to detect a single A2N event, that single A2N event may actually be associated with multiple A2N errors. Accordingly, in a first example, if a quantity of A2N events detected based on PUCCH errors occur within a time window satisfy a threshold condition (e.g., the quantity of A2N events within the time window is greater than or equal to a non-zero integer), then the UE 104 may increase transmit power of feedback transmissions, and/or generate and transmit a report to the network entity 102 notifying the network entity of one or more of the A2N events.

In a second example, if a ratio of A2N events detected based on PUCCH errors within a time window satisfies a threshold condition (e.g., a ratio of a number of A2N events detected based on PUCCH errors to a total number of PUCCH transmissions within the time window is greater than or equal to a non-zero real number), then the UE 104 may increase transmit power of feedback transmissions, and/or generate and transmit a report to the network entity 102 notifying the network entity of one or more of the A2N events.

In another example, the A2N configuration message may configure the UE 104 to track a number of A2N events that are detected based on the UE 104 receiving and discarding data that the UE 104 had previously properly received and ACK'd. As used throughout the specification, this type of A2N event may be referred to as a “PDSCH error.” It should be noted that the UE 104 may track one PDSCH error for each TB of data that the UE 104 receives and discards due to that TB of data being redundant or duplicative (e.g., the UE 104 already properly received and decoded the data of a particular TB and has received the data again, indicating that the network entity 102 did not properly receive the previously transmitted HARQ feedback for that data). Thus, in a first example, if a quantity of A2N events based on PDSCH errors occur within a time window satisfy a threshold condition (e.g., the quantity of A2N events within the time window is greater than or equal to a non-zero integer), then the UE 104 may increase transmit power of subsequent feedback transmissions, and/or generate and transmit a report to the network entity 102 notifying the network entity of one or more of the A2N events.

In a second example, if a ratio of A2N events detected based on PDSCH errors within a time window satisfies a threshold condition (e.g., a ratio of a number of A2N events detected based on PDSCH errors to a total number of PDSCH receptions or total number of TBs received within the time window is greater than or equal to a non-zero real number), then the UE 104 may increase transmit power of feedback transmissions, and/or generate and transmit a report to the network entity 102 notifying the network entity of one or more of the A2N events.

### Examples of UE Action to Increase Transmission Power

In certain aspects, the A2N configuration message may indicate that the UE 104 may increase transmit power for an uplink transmission that carries HARQ feedback if the UE 104 detects an A2N event and/or if one or more A2N events detected within a time window satisfy a threshold condition, as discussed above. For instance, the UE 104 may correctly receive and decode a first data (e.g., second communication 504 illustrated in FIG. 5) from the network entity 102, then transmit a first ACK (e.g., third communication 506 illustrated in FIG. 5) in response to the first data. The first ACK may be transmitted using a first transmission power and via PUCCH or PUSCH. However, if the network entity 102 fails to properly receive the first ACK, it may retransmit the first data (e.g., fifth communication 510 illustrated in FIG. 5) to the UE 104. Upon receiving the retransmission, the UE 104 may detect that an A2N event has occurred (e.g., based on a PUCCH error and/or PDSCH error, as illustrated in a first process 512 of FIG. 5) and discard the retransmitted data (e.g., second process 514 illustrated in FIG. 5). The UE 104 may then perform an action by increasing the transmission power (e.g., from the first transmission power to a second transmission power) used to transmit a subsequent ACK to the network entity 102. Thus, in response to the detected A2N event, the UE 104 may transmit an ACK (e.g., sixth communication 516 illustrated in FIG. 5) at a higher transmission power in response to the retransmitted data.

It should be noted that in this example, the UE 104 may perform the action of increasing the transmission power of the HARQ feedback for the retransmitted data based on the A2N event associated with the retransmitted data satisfying a threshold condition. In other words, in some examples, the UE's performance of the action (e.g., increasing HARQ feedback power) is not necessarily in response to the retransmitted data itself, but rather in response to the associated A2N event and whether the event triggers performance of the action. Thus, if the A2N event associated with the retransmitted data does not satisfy a threshold condition (e.g., the A2N event is the nth A2N event to be detected within a given time window, where an mth A2N event triggers the UE 104 to perform the action, and where n<m), then the UE 104 may refrain from performing any action associated with the retransmitted data and the associated A2N event. Moreover, if the A2N event associated with the retransmitted data satisfies a threshold condition that triggers the UE 104 to perform the action of increasing the transmission power of the HARQ feedback for the retransmitted data, then the UE 104 may also increase the transmission power of subsequent HARQ feedback associated with other retransmitted data.

In some examples, the A2N configuration message may configure the UE 104 with a transmission power offset value (e.g., a non-zero integer) in terms of dB, for example. Thus, when the UE 104 transmits a subsequent HARQ feedback message or a PUCCH signal, the UE 104 increase its transmission power of the PUCCH by the offset value relative to a previous transmission power used prior to detection of the A2N event. In other words, based on how the UE 104 is configured, the UE 104 may increase its PUCCH transmission power by the offset value in response to a detected A2N event, or in response to a quantity or ratio of detected A2N events satisfying a threshold condition.

In another example, the A2N configuration message may configure the UE 104 with a plurality of A2N threshold conditions and a power offset value corresponding to each threshold condition. Table 1 below illustrates an example configuration of different power offset values associated with A2N thresholds.

TABLE 1

| | |
|---|---|
| Power Offset Value | A2N Event Threshold |

| | | |
|---|---|---|
| 0 | dB | <2% |
| 3 | dB | Between 2% and 5% |
| 6 | dB | Between 5% and 10% |
| 10 | dB | ≥10% |

As shown in Table 1, if a ratio of detected A2N events (either PUCCH error or PDSCH error) is less than 2%, then the UE 104 may refrain from increasing a transmit power associated with transmission of a HARQ feedback message. Thus, if A2N events detected within a time window are relatively low, the UE 104 may refrain from taking any action. However, as the ratio of detected A2N events increases, the UE 104 may increase a transmit power associated with transmission of feedback transmissions by 3 dB, 6 dB, or 10 dB, depending on whether the ratio falls within a particular range (e.g., between 2% and 5%, between 5% and 10%, or greater than or equal to 10%).

Although Table 1 shows an A2N event threshold in terms of ratios, the UE 104 may also be configured with power offset values associated with ranges of integers indicating a number or quantity of A2N events detected within a time window. Moreover, the values provided in Table 1 are examples, and any suitable values may be used for power offset and A2N event threshold.

In another example, the A2N configuration message may configure the UE 104 with a formula or function by which the UE 104 can determine or calculate a power offset value. For example, the UE 104 may use the formula to calculate a power offset value based on a number or ratio of A2N events detected within a time window.

In certain aspects, the UE 104 may be configured to transmit a HARQ feedback message via PUCCH and/or via multiplexing the HARQ feedback message within a PUSCH. For example, the PUSCH may carry the HARQ feedback message via one or more REs. In some examples, the A2N configuration message may configure the UE 104 to apply an increased transmission power to an entire PUSCH transmission that carries the HARQ feedback message or limit the increased transmission to the REs of the PUSCH that carry the HARQ feedback message. In the latter example, the UE 104 may increase transmission of the HARQ feedback message REs according to a power offset value but transmit the remaining signaling of the PUSCH using a transmit power that is not increased by the offset value. In another example, the A2N configuration message may configure the UE 104 to apply an increased transmission power to PUCCH transmissions that carry a HARQ feedback message while refraining from increasing the transmission of a PUSCH even if it carries a HARQ feedback message.

### Examples of UE Action to Generate and Transmit Report

In certain aspects, the A2N configuration message (e.g., first communication 502 of FIG. 5) may indicate that the UE 104 may generate and transmit a report (e.g., an optional seventh communication 518 as illustrated in FIG. 5) to the network entity 102 in response to detecting an A2N event. The report may be configured to provide the network entity 102 with information about one or more A2N events detected by the UE 104.

In some examples, the A2N configuration message may configure the UE 104 to transmit the report via one or more of a MAC-CE or uplink control information (UCI) via a PUSCH (e.g., with UCI multiplexed into the PUSCH) or PUCCH transmission. The UE 104 may also, or alternatively, configure the UE 104 to transmit the report on an event-triggered or periodic basis. For example, the UE 104 may be triggered to transmit a report each time it detects an A2N event, or the UE 104 may be triggered to transmit a report if one or more A2N events detected within a time window satisfy a threshold condition, as described above. It should be noted that the UE 104 may be configured to perform a transmission power increase as well as generate and transmit a report, or one or the other.

In some examples, the A2N configuration message may configure the UE 104 to include certain information in the report. For example, if the UE 104 generates and transmits a report for each A2N event detected, the report may include an indication of one or more parameters associated with the A2N event and/or the downlink/uplink communications associated with the A2N event. Such parameters may include: a component carrier (CC) index, a HARQ process number, a slot index, and/or any other suitable parameter related to the A2N event. Such information may provide the network entity 102 with an indication of specific issues that the network may correct with an additional configuration message (e.g., eighth communication 522 of FIG. 5). For example, if A2N events tends to occur for PUCCH transmissions in a specific slot, the PUCCH error may be due to some interference with a specific pattern or due to overlap with some reference signals, etc.

If the UE 104 is configured to generate and transmit a report for A2N events that satisfy a threshold condition within a window of time, the UE 104 may include information about the window of time and the above discussed parameters associated with one or more of the A2N events detected within the window of time.

In some examples, the A2N configuration message may configure the UE 104 with a prohibit timer configured to prevent the UE 104 from transmitting additional reports within the duration of the timer. For example, the UE 104 may be configured to start the prohibit timer upon transmission of a report to the network entity 102. Although additional A2N events may occur after transmission of the report and within the duration of the prohibit timer, the UE 104 may refrain from transmitting an additional report until after expiration of the prohibit timer. The A2N configuration message may include an indication of the duration of the timer. The prohibit timer may ensure that the UE 104 does not report the same A2N event multiple times.

In certain aspects, the network entity 102 may receive the report (e.g., seventh communication 518) and, based on the report contents, determine an action (e.g., optional third process 520 illustrated in FIG. 5) to be taken by one or both of the UE 104 and the network entity 102 to reduce or eliminate A2N events. In some examples, the network entity 102 may determine to transmit uplink configuration information (e.g., optional eighth communication 522) to the UE 104, wherein the uplink configuration information is configured to adjust one or more parameters used by the UE 104 for uplink transmissions. In one example, the uplink configuration information may include a transmission power control (TPC) command configured to cause the UE 104 to increase the transmission power of its uplink transmissions (e.g., PUCCH carrying HARQ feedback messages). It should be noted that this example may be implemented if the UE 104 is not configured to automatically increase its uplink transmit power without any command from the network entity 102.

In another example, the uplink configuration information may be configured to enable the UE 104 to transmit PUCCH repetitions or enable the UE 104 to transmit a larger number of PUCCH repetitions. By enabling or increasing the number of PUCCH repetitions transmitted by the UE 104, the network entity 102 is more likely to correctly receive HARQ feedback transmitted by the UE 104, thereby reducing or eliminating the number of A2N events detected by the UE 104.

In another example, the uplink configuration information may be configured to cause the UE 104 to use spatial- and/or time-domain HARQ feedback bundling. HARQ feedback bundling is a technique wherein a UE 104 may group multiple ACK/NACK bits into a single bit. Such bundling may be used in wireless communication systems to improve data transmission reliability, particularly in scenarios with poor signal quality and/or high interference. Moreover, HARQ feedback bundling may reduce the payload size and improve PUCCH decoding success rate at the network entity 102.

The uplink configuration information may configure the UE 104 for time-domain HARQ feedback bundling. In this example, the UE 104 may bundle together multiple ACKs/NACKs in response to receiving data that was transmitted at different times. For instance, if the UE 104 receives multiple TBs of data in quick succession, it may bundle the ACKs/NACKs for the multiple TBs together into a single bit (e.g., PUCCH).

The uplink configuration information may configure the UE 104 for spatial-domain HARQ feedback bundling. In this example, the UE 104 may bundle together multiple ACKs/NACKs in response to receiving data that was transmitted via different spatial paths. For instance, if the UE 104 is using multiple antennas (e.g., MIMO), it may bundle the ACKs/NACKs for all the data received via different antennas into a single bit.

In some examples, the uplink configuration information may cause the UE 104 to change from a current PUCCH cell to another PUCCH cell if the network entity 102 determines that there is another CC with better channel conditions relative to the current. In some examples, the uplink configuration information may trigger a handover from the current cell (e.g., for which the network entity 102 is, or is associated with, a serving cell) to another cell. For instance, based on the report, the network entity 102 may determine that the UE 104 is within or near a cell coverage edge of the network entity 102, and/or that the UE 104 is closer to a neighboring cell.

As discussed, the UE 104 may be configured to detect, and perform an action in response to, an A2N event. The action may include one or more of increasing transmit power of a HARQ feedback message and/or generating and transmitting a report of the A2N event to a network entity 102. If the UE 104 is not pre-configured to perform the one or more actions, the A2N configuration message (e.g., first communication 502) may configure the UE 104 to perform one or more of increasing transmit power of a HARQ feedback message and/or generating and transmitting a report of the A2N event. In this case, the network entity 102 may enable and disable the actions taken by the UE 104 in response to an A2N event.

In some examples, an A2N configuration message may be an RRC message. In some examples, the A2N configuration message may be configured per cell group, per CC, or per traffic priority. For example, a particular A2N configuration message may be applied to all CCs in a cell group or may be applied per CC. Moreover, the network entity 102 may configure an A2N configuration message so that it applies only to high priority communications.

Although the above disclosure describes the UE 104 being configured by the network entity to detect A2N events and/or perform certain actions in response to A2N events, the UE 104 may be preconfigured to detect A2N events and/or perform one or more of the actions described above. For example, the UE 104 may be manufactured to perform one or more of the actions described above if, for example, the actions are defined in a cellular communications standard (e.g., 3GPP) specification, or if the manufacturer of the UE 104 includes the one or more actions in the design of the UE 104.

In the case the UE 104 is preconfigured to detect and/or perform one or more of the actions described above, the UE 104 may transmit signaling (e.g., initial communication 501 illustrated in FIG. 5) to the network entity 102 indicating the preconfigured capabilities of the UE 104. The initial communication 501 may provide the network entity 102 with an indication of A2N detection and/or corrective actions that the UE 104 is configured to perform in response to A2N detection.

If the UE 104 is preconfigured to increase transmit power of a HARQ feedback message and/or generate and transmit a report of the A2N event, then the network entity 102 may be configured to enable/disable one or both actions at the UE 104 via the A2N configuration message (e.g., first communication 502) and/or the uplink configuration message (e.g., eighth communication 522). Thus, the network entity 102 may determine which UE-side action(s) to enable or disable at a given point in time.

It should be noted that the methods and techniques described above may also reduce N2A events. For example, an N2A event typically occurs due to an error in transmission or decoding at the network entity 102, which causes the network entity 102 to interpret the NACK as an ACK. However, if the UE 104 performs the action of increasing transmit power of HARQ feedback messages, transmission and decoding errors that cause N2A errors may be reduced or eliminated. Moreover, if the UE 104 reports A2N events and the network entity 102 responds with one or more of the messages described above in connection with the eighth communication 522 (e.g., TPC command), future N2A events may be reduced when HARQ feedback messages transmitted by the UE 104 are transmitted with higher power, are bundled, or are transmitted to another serving cell closer to the UE 104.

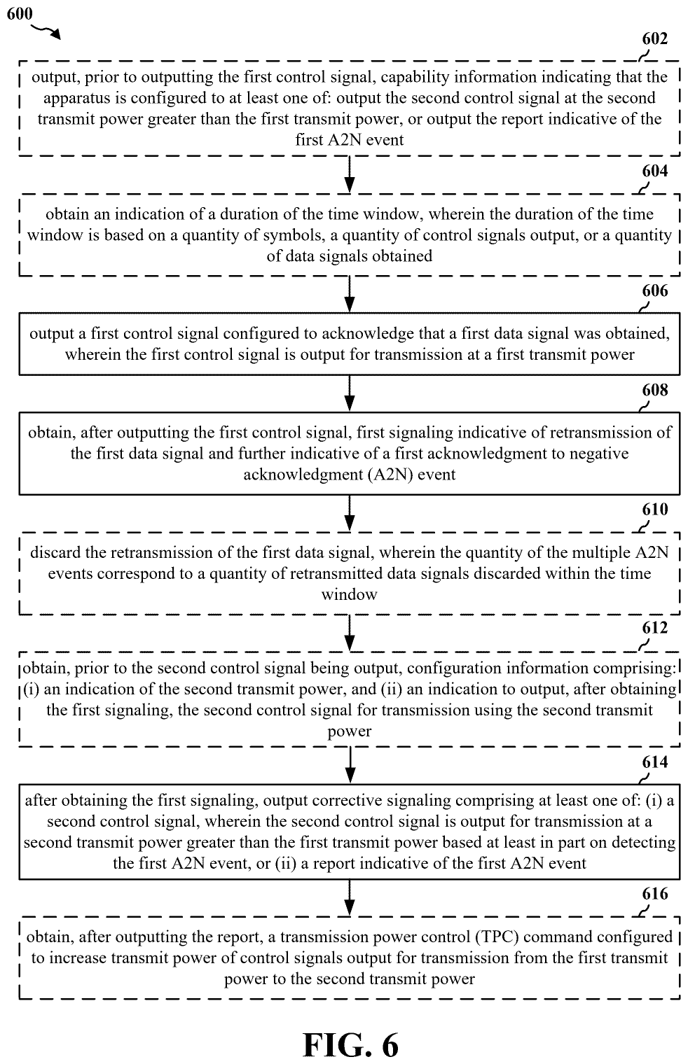

FIG. 6 is a flowchart 600 of a method of wireless communication. The method may be performed by a UE (e.g., the UE 104; the apparatus 802). Specifically, the method may be performed by one or more memories, processors, and RF front ends (e.g., the memory 360, controller/processor 359, transmitter 354TX, receiver 354RX, antenna 352, etc. of FIG. 3).

At 602, the UE may optionally output, prior to outputting the first control signal, capability information indicating that the apparatus is configured to at least one of: output the second control signal at the second transmit power greater than the first transmit power, or output the report indicative of the first A2N event. For example, 602 may be performed by an output component 840. Here, the UE 104 may indicate whether it has the capability to detect an A2N event, and if it has that capability, whether the UE 104 is capable of taking one or more actions in response to such a detection. For example, the UE 104 may indicate that it is capable of automatically (e.g., without command from a network entity) increasing transmission power of a feedback transmission in response to an A2N event. In another example, the UE 104 may indicate that it is capable of generating and transmitting a report of the detected A2N event to the network node. In some examples, the UE 104 may indicate that it is capable of both increasing the HARQ feedback transmit power and transmitting the report. The UE 104 may indicate its capability/capabilities via the initial communication 501 illustrated in FIG. 5.

At 604, the UE may optionally obtain an indication of a duration of the time window, wherein the duration of the time window is based on a quantity of symbols, a quantity of control signals output, or a quantity of data signals obtained. For example, 604 may be performed by an obtain component 842. Here, the UE 104 may receive an indication of a time window duration within which the UE 104 may track A2N events. In some examples, if the number (e.g., quantity) of A2N events detected by the UE 104 within the duration of the time window satisfies a threshold condition, then the UE 104 may perform an action (e.g., increase transmit power of a feedback transmission and/or transmit a report to the network entity 102). The time window duration may be a given in terms of a quantity of slots or symbols, or may be a function of a quantity of control signals output by the UE 104, or a quantity of data signals obtained by the UE 104 from the network entity 102. The indication of the time window, its duration, and the threshold condition may be obtained by the UE 104 as part of a first communication 502 and/or the eighth communication 522 illustrated in FIG. 5. The indication may be transmitted via an RRC message.

At 606, the UE may output a first control signal configured to acknowledge that a first data signal was obtained, wherein the first control signal is output for transmission at a first transmit power. For example, 606 may be performed by the output component 840. Here, in response to correctly receiving and decoding data transmitted by the network entity 102, the UE 104 may transmit HARQ feedback to the network entity 102 confirming that the data was correctly received and decoded. In the example of FIG. 5 the second communication 504 may correspond to the first data signal and the third communication 506 may correspond to the HARQ feedback transmitted in response.

At 608, the UE may obtain, after outputting the first control signal, first signaling indicative of retransmission of the first data signal and further indicative of a first acknowledgment to negative acknowledgment (A2N) event. For example, 608 may be performed by the obtain component 842. Here, the UE 104 may receive a downlink grant or DCI indicating that the first data signal will be retransmitted to the UE 104. This redundant retransmission may indicate to the UE 104 that an A2N event has occurred. In the example of FIG. 5 the fourth communication 508 may correspond to the first signaling indicative of retransmission, the fifth communication 510 may correspond to a retransmission of the first data signal, and the first process 512 may correspond to the UE 104 detecting that an A2N event has occurred.

At 610, the UE may optionally discard the retransmission of the first data signal, wherein the quantity of the multiple A2N events correspond to a quantity of retransmitted data signals discarded within the time window. For example, 610 may be performed by a discard component 844. Here, the UE 104 may discard the retransmitted data signal if that data signal was previously received and properly decoded at the UE 104. In the example of FIG. 5 the second process 514 may correspond to the discard of the retransmitted data signal. It should be noted that in some examples, the UE 104 may be configured to take action if the quantity of detected A2N events satisfies a threshold condition. In this example, the number of retransmitted data signals that are discarded within the time window may be the number of detected A2N events. If the number of discarded signals or detected A2N events satisfies the threshold condition, the UE 104 may take action.

At 612, the UE may optionally obtain, prior to the second control signal being output, configuration information comprising: (i) an indication of the second transmit power, and (ii) an indication to output, after obtaining the first signaling, the second control signal for transmission using the second transmit power. For example, 612 may be performed by the obtain component 842. Here, the network entity 102 may configure the UE 104 to take an action by increasing a transmit power of subsequent ACK signaling if the UE 104 detects one or more A2N events, as illustrated in the first communication 502 of FIG. 5. Alternatively, the UE 104 may transmit a report to the network entity 102 providing the network entity 102 with information about a detected A2N event, as illustrated in the seventh communication 518 of FIG. 5. In response, the network entity 102 may transmit a command to the UE 104 configuring the UE 104 to increase its transmit power of ACK signaling, as illustrated in the eighth communication 522 of FIG. 5. In either example, the UE 104 may transmit an ACK in response to a retransmission of a previously received data signal, wherein the ACK is transmitted at a higher power level than a previous ACK transmitted in response to the original data signal.

At 614, the UE may, after obtaining the first signaling, output corrective signaling comprising at least one of: (i) a second control signal, wherein the second control signal is output for transmission at a second transmit power greater than the first transmit power based at least in part on the first A2N event, or (ii) a report indicative of the first A2N event. For example, 614 may be performed by the obtain component 842. Here, in response to receiving the retransmission of the data signal, the UE 104 may transmit an ACK signal at a higher transmission power relative to an ACK transmitted in response to the original transmission of the data signal, as illustrated in the sixth communication 516 of FIG. 5. Alternatively, or in addition, the UE 104 may transmit a report indicating that the first signaling is indicative of a A2N event, as illustrated in the seventh communication 518 of FIG. 5.

At 616, the UE may optionally obtain, after outputting the report, a transmission power control (TPC) command configured to increase transmit power of control signals output for transmission from the first transmit power to the second transmit power. For example, 616 may be performed by the obtain component 842. Here, the UE 104 may receive signaling from the network entity 102 configured to cause the UE 104 to increase transmission power of ACK signaling. The TPC command may be transmitted in response to a report indicating one or more A2N events detected by the UE 104. If the UE 104 is configured to automatically increase its transmission power in response to detecting an A2N event, then the TPC command may provide the UE 104 with a different transmission power offset than that used by the UE 104. If the UE 104 is not configured to automatically increase its transmission power in response to detecting an A2N event, then the TPC command may provide the UE 104 with the configuration to increase its ACK transmit power.

In certain aspects, the first A2N event is one of multiple A2N events within a time window, and wherein the corrective signaling is output based on a quantity of the multiple A2N events satisfying a threshold condition.

In certain aspects, the quantity of the multiple A2N events correspond to a quantity of retransmitted data signals obtained within the time window, and wherein the retransmitted data signals include the retransmission of the first data signal.

In certain aspects, each of the retransmitted data signals is a retransmission of a physical downlink shared channel (PDSCH) transmission or a retransmission of a transport block (TB).

In certain aspects, the first A2N event is one of multiple A2N events within a time window.

In certain aspects, the first control signal is one of multiple control signals output within a time window, and wherein the corrective signaling is output when a ratio of: (i) a quantity of A2N events associated with the multiple control signals, and (ii) a quantity of the multiple control signals, satisfies a threshold condition.

In certain aspects, the first data signal is one of multiple data signals obtained within a time window, and wherein the corrective signaling is output based on a ratio of: (i) a quantity of A2N events associated with the multiple data signals, and (ii) a quantity of the multiple data signals, satisfying a threshold condition.

In certain aspects, the configuration information further comprises: an indication of multiple transmit powers including the second transmit power, and an indication of one or more A2N event thresholds each configured to trigger a corresponding transmit power of the multiple transmit powers.

In certain aspects, the second control signal is multiplexed on a physical uplink shared channel (PUSCH), and wherein the PUSCH is output for transmission at the second transmit power.

In certain aspects, the second control signal is output for transmission via a physical uplink control channel (PUCCH), and wherein the PUCCH is output for transmission at the second transmit power.

In certain aspects, the report is output via a medium access control-control element (MAC-CE) or uplink control information (UCI) message.

In certain aspects, the report comprises an indication of at least one of: a component carrier (CC) index associated with the first A2N event, an identifier associated with the first control signal, or an identifier associated with a slot via which the first control signal was output.

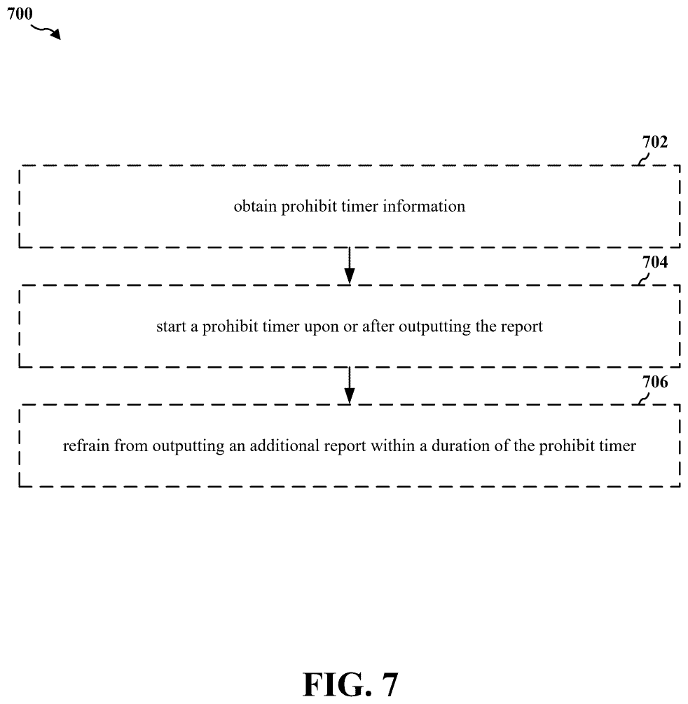

FIG. 7 is a flowchart 700 of a method of wireless communication. The method may be performed by a UE (e.g., the UE 104; the apparatus 802) and may include one or more of the blocks illustrated in FIG. 6. Specifically, the method may be performed by one or more memories, processors, and RF front ends (e.g., the memory 360, controller/processor 359, transmitter 354TX, receiver 354RX, antenna 352, etc. of FIG. 3).

At 702, the UE may optionally obtain prohibit timer information. For example, 702 may be performed by the obtain component 842. Here, the network entity 102 may transmit prohibit timer information to the UE 104 (e.g., via one or more of the first communication 502 and/or the eighth communication 522 of FIG. 5).

At 704, the UE may optionally start a prohibit timer upon or after outputting the report. For example, 704 may be performed by a start component 846. Here, the UE 104 may start the prohibit timer which may be configured to prevent the UE 104 from transmitting additional reports for the duration of the timer. Accordingly, the timer may prevent the transmission of multiple redundant reports.

Finally, at 706, the UE may optionally refrain from outputting an additional report within the time duration. For example, 706 may be performed by a refrain component 848.

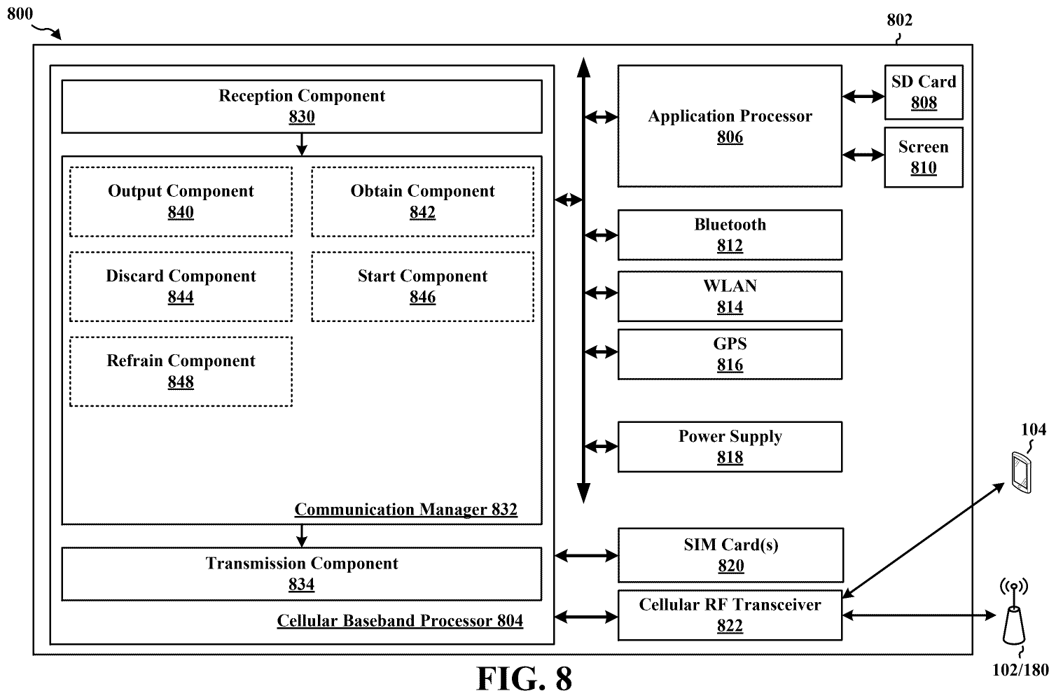

FIG. 8 is a diagram 800 illustrating an example of a hardware implementation for an apparatus 802. The apparatus 802 is a UE and includes a cellular baseband processor 804 (also referred to as a modem) coupled to one or more cellular RF transceivers 822 and one or more subscriber identity modules (SIM) cards 820, an application processor 806 coupled to a secure digital (SD) card 808 and a screen 810, a Bluetooth module 812, a wireless local area network (WLAN) module 814, a Global Positioning System (GPS) module 816, and a power supply 818. The cellular baseband processor 804 communicates through the one or more cellular RF transceivers 822 with the UE 104 and/or BS 102/180. The cellular baseband processor 804 may include a computer-readable medium/memory. The computer-readable medium/memory may be non-transitory. The cellular baseband processor 804 is responsible for general processing, including the execution of software stored on the computer-readable medium/memory. The software, when executed by the cellular baseband processor 804, causes the cellular baseband processor 804 to perform the various functions described supra. The computer-readable medium/memory may also be used for storing data that is manipulated by the cellular baseband processor 804 when executing software. The cellular baseband processor 804 further includes a reception component 830, a communication manager 832, and a transmission component 834. The communication manager 832 includes the one or more illustrated components. The components within the communication manager 832 may be stored in the computer-readable medium/memory and/or configured as hardware within the cellular baseband processor 804. The cellular baseband processor 804 may be a component of the UE 104 and may include the memory 360 and/or at least one of the TX processor 368, the RX processor 356, and the controller/processor 359. In one configuration, the apparatus 802 may be a modem chip and include just the baseband processor 804, and in another configuration, the apparatus 802 may be the entire UE (e.g., see UE 104 of FIG. 3) and include the aforediscussed additional modules of the apparatus 802. In various examples, the apparatus 802 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 832 includes an output component 840 configured to: output, prior to outputting the first control signal, capability information indicating that the apparatus is configured to at least one of: output the second control signal at the second transmit power greater than the first transmit power, or output the report indicative of the first A2N event; output a first control signal configured to acknowledge that a first data signal was obtained, wherein the first control signal is output for transmission at a first transmit power; and after obtaining the first signaling, output corrective signaling comprising at least one of: (i) a second control signal, wherein the second control signal is output for transmission at a second transmit power greater than the first transmit power based at least in part on the first A2N event, or (ii) a report indicative of the first A2N event; e.g., as described in connection with 602, 606, and 614 of FIG. 6.

The communication manager 832 further includes an obtain component 842 configured to obtain an indication of a duration of the time window, wherein the duration of the time window is based on a quantity of symbols, a quantity of control signals output, or a quantity of data signals obtained; obtain, after outputting the first control signal, first signaling indicative of retransmission of the first data signal and further indicative of a first acknowledgment to negative acknowledgment (A2N) event; obtain, prior to the second control signal being output, configuration information comprising: (i) an indication of the second transmit power, and (ii) an indication to output, after obtaining the first signaling, the second control signal for transmission using the second transmit power; obtain, after outputting the report, a transmission power control (TPC) command configured to increase transmit power of control signals output for transmission from the first transmit power to the second transmit power; and obtain prohibit timer information; e.g., as described in connection with 604, 608, 612, 616, and 702.

The communication manager 832 further includes a discard component 844 configured to discard the retransmission of the first data signal, wherein the quantity of the multiple A2N events correspond to a quantity of retransmitted data signals discarded within the time window, e.g., as described in connection with 610.

The communication manager 832 further includes a start component 846 configured to start a prohibit timer upon or after outputting the report, e.g., as described in connection with 704.

The communication manager 832 further includes a refrain component 848 configured to refrain from outputting an additional report within the time duration, e.g., as described in connection with 706.

The apparatus may include additional components that perform each of the blocks of the algorithm in the aforementioned flowcharts of FIGS. 6 and 7. As such, each block in the aforementioned flowcharts may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 802, and in particular the cellular baseband processor 804, includes: means for outputting, prior to outputting the first control signal, capability information indicating that the apparatus is configured to at least one of: output the second control signal at the second transmit power greater than the first transmit power, or output the report indicative of the first A2N event; means for obtaining an indication of a duration of the time window, wherein the duration of the time window is based on a quantity of symbols, a quantity of control signals output, or a quantity of data signals obtained; means for outputting a first control signal configured to acknowledge that a first data signal was obtained, wherein the first control signal is output for transmission at a first transmit power; means for obtaining, after outputting the first control signal, first signaling indicative of retransmission of the first data signal and further indicative of a first acknowledgment to negative acknowledgment (A2N) event; means for discarding the retransmission of the first data signal, wherein the quantity of the multiple A2N events correspond to a quantity of retransmitted data signals discarded within the time window; means for obtaining, prior to the second control signal being output, configuration information comprising: (i) an indication of the second transmit power, and (ii) an indication to output, after obtaining the first signaling, the second control signal for transmission using the second transmit power; means for, after obtaining the first signaling, outputting corrective signaling comprising at least one of: (i) a second control signal, wherein the second control signal is output for transmission at a second transmit power greater than the first transmit power based at least in part on the first A2N event, or (ii) a report indicative of the first A2N event; means for obtaining, after outputting the report, a transmission power control (TPC) command configured to increase transmit power of control signals output for transmission from the first transmit power to the second transmit power; means for obtaining prohibit timer information; means for starting a prohibit timer upon or after outputting the report; and means for refraining from outputting an additional report within the time duration.

The aforementioned means may be one or more of the aforementioned components of the apparatus 802 configured to perform the functions recited by the aforementioned means. As described supra, the apparatus 802 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Means for receiving or means for obtaining may include a receiver sch as the receive processor 356 and/or antenna(s) 352 of the UE 104 illustrated in FIG. 3. Means for transmitting or means for outputting may include a transmitter such as the transmit processor 368 or antenna(s) 352 of the UE 104 illustrated in FIG. 3. Means for starting, means for discarding, and means for refraining may include a processing system, which may include one or more processors, such as the controller/processor 359, the memory 360, and/or any other suitable hardware components of the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

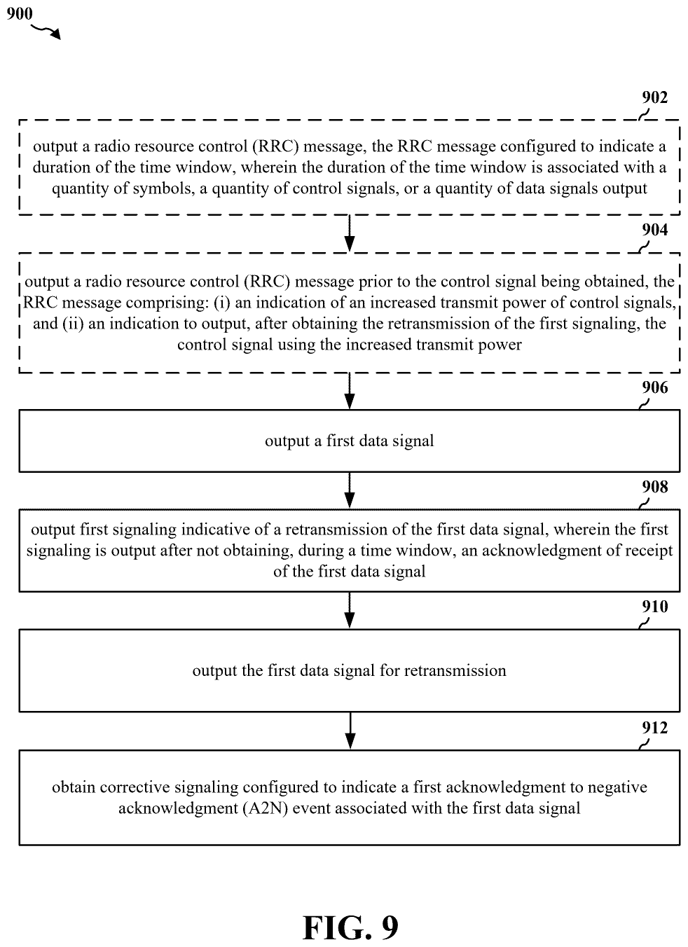

FIG. 9 is a flowchart 900 of a method of wireless communication. The method may be performed by a network entity or base station (e.g., the base station 102/180; the apparatus 1002. Specifically, the method may be performed by one or more memories, processors, and RF front ends (e.g., the memory 376, controller/processor 375, transmitter 318TX, receiver 318RX, antenna 320, etc. of FIG. 3).

At 902, the network entity may optionally output a radio resource control (RRC) message, the RRC message configured to indicate a duration of the time window, wherein the duration of the time window is associated with a quantity of symbols, a quantity of control signals, or a quantity of data signals output. For example, 902 may be performed by an output component 1040.

At 904, the network entity may optionally output a radio resource control (RRC) message prior to the control signal being obtained, the RRC message comprising: (i) an indication of an increased transmit power of control signals, and (ii) an indication to output, after obtaining the retransmission of the first signaling, the control signal using the increased transmit power. For example, 904 may be performed by the output component 1040.

At 906, the network entity may output a first data signal. For example, 906 may be performed by the output component 1040.

At 908, the network entity may output first signaling indicative of a retransmission of the first data signal, wherein the first signaling is output after not obtaining, during a time window, an acknowledgment of receipt of the first data signal. For example, 908 may be performed by the output component 1040.

At 910, the network entity may output the first data signal for retransmission. For example, 910 may be performed by the output component 1040.

At 912, the network entity may obtain corrective signaling configured to indicate a first acknowledgment to negative acknowledgment (A2N) event associated with the first data signal. For example, 912 may be performed by an obtain component 1042.

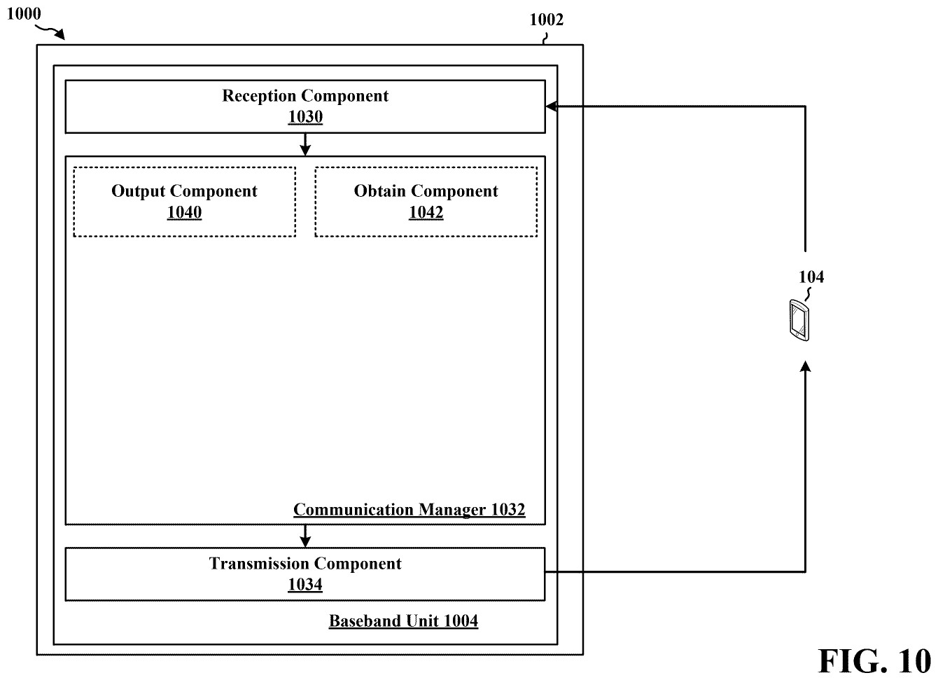

FIG. 10 is a diagram 1000 illustrating an example of a hardware implementation for an apparatus 1002. The apparatus 1002 is a BS and includes a baseband unit 1004. The baseband unit 1004 may communicate through one or more cellular RF transceivers with the UE 104. The baseband unit 1004 may include a computer-readable medium/memory. The baseband unit 1004 is responsible for general processing, including the execution of software stored on the computer-readable medium/memory. The software, when executed by the baseband unit 1004, causes the baseband unit 1004 to perform the various functions described supra. The computer-readable medium/memory may also be used for storing data that is manipulated by the baseband unit 1004 when executing software. The baseband unit 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the baseband unit 1004. The baseband unit 1004 may be a component of the BS 102/180 and may include the memory 376 and/or at least one of the TX processor 316, the RX processor 370, and the controller/processor 375. In various examples, the apparatus 1002 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1032 includes an output component 1040 configured to: output a radio resource control (RRC) message, the RRC message configured to indicate a duration of the time window, wherein the duration of the time window is associated with a quantity of symbols, a quantity of control signals, or a quantity of data signals output; output a radio resource control (RRC) message prior to the control signal being obtained, the RRC message comprising: (i) an indication of an increased transmit power of control signals, and (ii) an indication to output, after obtaining the retransmission of the first signaling, the control signal using the increased transmit power; output a first data signal; output first signaling indicative of a retransmission of the first data signal, wherein the first signaling is output after not obtaining, during a time window, an acknowledgment of receipt of the first data signal; output the first data signal for retransmission; and obtain corrective signaling configured to indicate a first acknowledgment to negative acknowledgment (A2N) event associated with the first data signal; e.g., as described in connection with 902, 904, 906, 908, and 910. The communication manager 1032 further includes an obtain component 1042 configured to obtain corrective signaling configured to indicate a first acknowledgment to negative acknowledgment (A2N) event associated with the first data signal, e.g., as described in connection with 912.

The apparatus may include additional components that perform each of the blocks of the algorithm in the aforementioned flowcharts of FIG. 9. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the baseband unit 1004, includes: means for outputting a radio resource control (RRC) message, the RRC message configured to indicate a duration of the time window, wherein the duration of the time window is associated with a quantity of symbols, a quantity of control signals, or a quantity of data signals output; means for outputting a radio resource control (RRC) message prior to the control signal being obtained, the RRC message comprising: (i) an indication of an increased transmit power of control signals, and (ii) an indication to output, after obtaining the retransmission of the first signaling, the control signal using the increased transmit power; means for outputting a first data signal; means for outputting first signaling indicative of a retransmission of the first data signal, wherein the first signaling is output after not obtaining, during a time window, an acknowledgment of receipt of the first data signal; means for outputting the first data signal for retransmission; and means for obtaining corrective signaling configured to indicate a first acknowledgment to negative acknowledgment (A2N) event associated with the first data signal.

The aforementioned means may be one or more of the aforementioned components of the apparatus 1002 configured to perform the functions recited by the aforementioned means. As described supra, the apparatus 1002 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Means for receiving or means for obtaining may include a receiver, such as the receive processor 370 and/or an antenna(s) 320 of the network entity 102/180 illustrated in FIG. 3. Means for transmitting or means for outputting may include a transmitter, such as the transmit processor 316 or an antenna(s) 320 of the network entity 102/180 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

### Additional Considerations

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### EXAMPLE ASPECTS

The following examples are illustrative only and may be combined with aspects of other embodiments or teachings described herein, without limitation.

Example 1 is a method for wireless communication at a wireless node, comprising: outputting a first control signal configured to acknowledge that a first data signal was obtained, wherein the first control signal is output for transmission at a first transmit power; obtaining, after outputting the first control signal, first signaling indicative of retransmission of the first data signal and further indicative of a first acknowledgment to negative acknowledgment (A2N) event; and after obtaining the first signaling, outputting corrective signaling comprising at least one of: (i) a second control signal, wherein the second control signal is output for transmission at a second transmit power greater than the first transmit power based at least in part on the first A2N event, or (ii) a report indicative of the first A2N event.

Example 2 is the method of Example 1, wherein the first A2N event is one of multiple A2N events within a time window, and wherein the corrective signaling is output based on a quantity of the multiple A2N events satisfying a threshold condition.

Example 3 is the method of Example 2, further comprising: obtaining an indication of a duration of the time window, wherein the duration of the time window is based on a quantity of symbols, a quantity of control signals output, or a quantity of data signals obtained.

Example 4 is the method of any of Examples 2 and 3, wherein the quantity of the multiple A2N events correspond to a quantity of retransmitted data signals obtained within the time window, and wherein the retransmitted data signals include the retransmission of the first data signal.

Example 5 is the method of Example 4, wherein each of the retransmitted data signals is a retransmission of a physical downlink shared channel (PDSCH) transmission or a retransmission of a transport block (TB).

Example 6 is the method of any of Examples 1-5, wherein the first A2N event is one of multiple A2N events within a time window, and wherein the method further comprises: discarding the retransmission of the first data signal, wherein the quantity of the multiple A2N events correspond to a quantity of retransmitted data signals discarded within the time window.

Example 7 is the method of any of Examples 1-6, wherein the first control signal is one of multiple control signals output within a time window, and wherein the corrective signaling is output when a ratio of: (i) a quantity of A2N events associated with the multiple control signals, and (ii) a quantity of the multiple control signals, satisfies a threshold condition.

Example 8 is the method of any of Examples 1-7, wherein the first data signal is one of multiple data signals obtained within a time window, and wherein the corrective signaling is output based on a ratio of: (i) a quantity of A2N events associated with the multiple data signals, and (ii) a quantity of the multiple data signals, satisfying a threshold condition.

Example 9 is the method of any of Examples 1-8, wherein the method further comprises: obtaining, prior to the second control signal being output, configuration information comprising: (i) an indication of the second transmit power, and (ii) an indication to output, after obtaining the first signaling, the second control signal for transmission using the second transmit power.

Example 10 is the method of Example 9, wherein the configuration information further comprises: an indication of multiple transmit powers including the second transmit power, and an indication of one or more A2N event thresholds each configured to trigger a corresponding transmit power of the multiple transmit powers.

Example 11 is the method of any of Examples 1-10, wherein the second control signal is multiplexed on a physical uplink shared channel (PUSCH), and wherein the PUSCH is output for transmission at the second transmit power.

Example 12 is the method of any of Examples 1-11, wherein the second control signal is output for transmission via a physical uplink control channel (PUCCH), and wherein the PUCCH is output for transmission at the second transmit power.

Example 13 is the method of any of Examples 1-12, wherein the report is output via a medium access control-control element (MAC-CE) or uplink control information (UCI) message.

Example 14 is the method of any of Examples 1-13, wherein the report comprises an indication of at least one of: a component carrier (CC) index associated with the first A2N event, an identifier associated with the first control signal, or an identifier associated with a slot via which the first control signal was output.

Example 15 is the method of any of Examples 1-14, further comprising: obtaining prohibit timer information; starting a prohibit timer upon or after outputting the report; and refraining from outputting an additional report within the time duration.

Example 16 is the method of any of Examples 1-15, further comprising: obtaining, after outputting the report, a transmission power control (TPC) command configured to increase transmit power of control signals output for transmission from the first transmit power to the second transmit power.

Example 17 is the method of any of Examples 1-16, further comprising: outputting, prior to outputting the first control signal, capability information indicating that the wireless node is configured to at least one of: output the second control signal at the second transmit power greater than the first transmit power, or output the report indicative of the first A2N event.

Example 18 is a method for wireless communication at a wireless node, comprising: outputting a first data signal; outputting first signaling indicative of a retransmission of the first data signal, wherein the first signaling is output after not obtaining, during a time window, an acknowledgment of receipt of the first data signal; outputting the first data signal for retransmission; and obtaining corrective signaling configured to indicate a first acknowledgment to negative acknowledgment (A2N) event associated with the first data signal.

Example 19 is the method of Example 18, wherein the corrective signaling comprises a report configured to indicate the first A2N event.

Example 20 is the method of any of Examples 18 and 19, wherein the first A2N event is one of multiple A2N events within a time window, and wherein the corrective signaling is further configured to indicate a quantity of the multiple A2N events satisfying a threshold condition.

Example 21 is the method of Example 20, further comprising: outputting a radio resource control (RRC) message, the RRC message configured to indicate a duration of the time window, wherein the duration of the time window is associated with a quantity of symbols, a quantity of control signals, or a quantity of data signals output.

Example 22 is the method of any of Examples 18-21, wherein the corrective signaling comprises a control signal configured to acknowledge that the retransmission of the first data signal was obtained, and wherein the method further comprises: outputting a radio resource control (RRC) message prior to the control signal being obtained, the RRC message comprising: (i) an indication of an increased transmit power of control signals, and (ii) an indication to output, after obtaining the retransmission of the first signaling, the control signal using the increased transmit power.

Example 23 is the method of Example 22, wherein the RRC message further comprises: an indication of multiple transmit powers for control signal transmission, the multiple transmit powers including the increased transmit power, and an indication of one or more A2N event thresholds each configured to trigger a corresponding transmit power of the multiple transmit powers.

Example 24 is the method of any of Examples 18-23, wherein the corrective signaling comprises a control signal configured to acknowledge that the retransmission of the first data signal was obtained, and wherein the control signal is multiplexed on, and obtained via a physical uplink shared channel (PUSCH).

Example 25 is the method of any of Examples 18-24, wherein the corrective signaling comprises a control signal indicating that the retransmission of the first data signal was obtained, and wherein the control signal is obtained via a physical uplink control channel (PUCCH).

Example 26 is the method of any of Examples 18-25, wherein the corrective signaling comprises a report indicative of the first A2N event, and wherein the report is obtained via a medium access control-control element (MAC-CE) or uplink control information (UCI) message.

Example 27 is an apparatus for wireless communications, comprising means for performing a method in accordance with any one of Examples 1-17.

Example 28 is an apparatus for wireless communications, comprising means for performing a method in accordance with any one of examples 18-26.

Example 29 is a non-transitory computer-readable medium comprising instructions that, when executed by a wireless node, cause the wireless node to perform a method in accordance with any one of examples 1-17.

Example 30 is a non-transitory computer-readable medium comprising instructions that, when executed by a wireless node, cause the wireless node to perform a method in accordance with any one of examples 18-26.

Example 31 is an apparatus for wireless communications, comprising: one or more memories, individually or in combination, having instructions; and one or more processors, individually or in combination, configured to execute the instructions and cause the apparatus to perform a method in accordance with any one of examples 1-17.

Example 32 is an apparatus for wireless communications, comprising: one or more memories, individually or in combination, having instructions; and one or more processors, individually or in combination, configured to execute the instructions and cause the apparatus to perform a method in accordance with any one of examples 18-26.

Example 33 is a wireless node, comprising: a transceiver; one or more memories, individually or in combination, having instructions; and one or more processors, individually or in combination, configured to execute the instructions and cause the wireless node to perform a method in accordance with any one of examples 1-17, wherein the transceiver is configured to: transmit the first control signal; receive first signaling; and output corrective signaling.

Example 34 is a wireless node, comprising: a transceiver; one or more memories, individually or in combination, having instructions; and one or more processors, individually or in combination, configured to execute the instructions and cause the wireless node to perform a method in accordance with any one of examples 18-26, wherein the transceiver is configured to: transmit the first data signal; transmit first signaling; transmit the first data signal for retransmission; and receive the corrective signaling.

What is claimed is:

1. An apparatus for wireless communication, comprising:
one or more memories, individually or in combination, having instructions; and
one or more processors, individually or in combination, configured to execute the instructions and cause the apparatus to:
output a first control signal configured to acknowledge that a first data signal was obtained, wherein the first control signal is output for transmission at a first transmit power;
obtain, after outputting the first control signal, first signaling indicative of retransmission of the first data signal and further indicative of a first acknowledgment to negative acknowledgment (A2N) event; and
after obtaining the first signaling, output corrective signaling comprising at least one of: (i) a second control signal, wherein the second control signal is output for transmission at a second transmit power greater than the first transmit power based at least in part on the first A2N event, or (ii) a report indicative of the first A2N event.

2. The apparatus of claim 1, wherein the first A2N event is one of multiple A2N events within a time window, and wherein the corrective signaling is output based on a quantity of the multiple A2N events satisfying a threshold condition.

3. The apparatus of claim 2, wherein the one or more processors, individually or in combination, are further configured to cause the apparatus to:
obtain an indication of a duration of the time window, wherein the duration of the time window is based on a quantity of symbols, a quantity of control signals output, or a quantity of data signals obtained.

4. The apparatus of claim 2, wherein the quantity of the multiple A2N events correspond to a quantity of retransmitted data signals obtained within the time window, and wherein the retransmitted data signals include the retransmission of the first data signal.

5. The apparatus of claim 4, wherein each of the retransmitted data signals is a retransmission of a physical downlink shared channel (PDSCH) transmission or a retransmission of a transport block (TB).

6. The apparatus of claim 1, wherein the first A2N event is one of multiple A2N events within a time window, and wherein the one or more processors, individually or in combination, are further configured to:
discard the retransmission of the first data signal, wherein a quantity of the multiple A2N events correspond to a quantity of retransmitted data signals discarded within the time window.

7. The apparatus of claim 1, wherein the first control signal is one of multiple control signals output within a time window, and wherein the corrective signaling is output when a ratio of: (i) a quantity of A2N events associated with the multiple control signals, and (ii) a quantity of the multiple control signals, satisfies a threshold condition.

8. The apparatus of claim 1, wherein the first data signal is one of multiple data signals obtained within a time window, and wherein the corrective signaling is output based on a ratio of: (i) a quantity of A2N events associated with the multiple data signals, and (ii) a quantity of the multiple data signals, satisfying a threshold condition.

9. The apparatus of claim 1, wherein the one or more processors, individually or in combination, are further configured to cause the apparatus to:
obtain, prior to the second control signal being output, configuration information comprising: (i) an indication of the second transmit power, and (ii) an indication to output, after obtaining the first signaling, the second control signal for transmission using the second transmit power.

10. The apparatus of claim 9, wherein the configuration information further comprises:
an indication of multiple transmit powers including the second transmit power, and
an indication of one or more A2N event thresholds each configured to trigger a corresponding transmit power of the multiple transmit powers.

11. The apparatus of claim 1, wherein the second control signal is multiplexed on a physical uplink shared channel (PUSCH), and wherein the PUSCH is output for transmission at the second transmit power.

12. The apparatus of claim 1, wherein the second control signal is output for transmission via a physical uplink control channel (PUCCH), and wherein the PUCCH is output for transmission at the second transmit power.

13. The apparatus of claim 1, wherein the report is output via a medium access control-control element (MAC-CE) or uplink control information (UCI) message.

14. The apparatus of claim 1, wherein the report comprises an indication of at least one of: a component carrier (CC) index associated with the first A2N event, an identifier associated with the first control signal, or an identifier associated with a slot via which the first control signal was output.

15. The apparatus of claim 1, wherein the one or more processors, individually or in combination, are further configured to cause the apparatus to:
obtain prohibit timer information;
start a prohibit timer upon or after outputting the report; and
refrain from outputting an additional report within a duration of the prohibit timer.

16. The apparatus of claim 1, wherein the one or more processors, individually or in combination, are further configured to cause the apparatus to:
obtain, after outputting the report, a transmission power control (TPC) command configured to increase transmit power of control signals output for transmission from the first transmit power to the second transmit power.

17. The apparatus of claim 1, wherein the one or more processors, individually or in combination, are further configured to cause the apparatus to:
output, prior to outputting the first control signal, capability information indicating that the apparatus is configured to at least one of: output the second control signal at the second transmit power greater than the first transmit power, or output the report indicative of the first A2N event.

18. The apparatus of claim 1, further comprising a transceiver configured to:
transmit the first control signal;
receive the first signaling; and
transmit the corrective signaling, wherein the apparatus is configured as a user equipment (UE).

19. An apparatus for wireless communication, comprising:
one or more memories, individually or in combination, having instructions; and
one or more processors, individually or in combination, configured to execute the instructions and cause the apparatus to:
output a first data signal;
output first signaling indicative of a retransmission of the first data signal, wherein the first signaling is output after not obtaining, during a time window, an acknowledgment of receipt of the first data signal;
output the first data signal for retransmission; and
obtain corrective signaling configured to indicate a first acknowledgment to negative acknowledgment (A2N) event associated with the first data signal.

20. The apparatus of claim 19, wherein the corrective signaling comprises a report configured to indicate the first A2N event.

21. The apparatus of claim 19, wherein the first A2N event is one of multiple A2N events within a time window, and wherein the corrective signaling is further configured to indicate a quantity of the multiple A2N events satisfying a threshold condition.

22. The apparatus of claim 21, wherein the one or more processors, individually or in combination, are further configured to cause the apparatus to:
output a radio resource control (RRC) message, the RRC message configured to indicate a duration of the time window, wherein the duration of the time window is associated with a quantity of symbols, a quantity of control signals, or a quantity of data signals output.

23. The apparatus of claim 19, wherein the corrective signaling comprises a control signal configured to acknowledge that the retransmission of the first data signal was obtained, and wherein the one or more processors, individually or in combination, are further configured to cause the apparatus to:
output a radio resource control (RRC) message prior to the control signal being obtained, the RRC message comprising: (i) an indication of an increased transmit power of control signals, and (ii) an indication to output, after obtaining the retransmission of the first signaling, the control signal using the increased transmit power.

24. The apparatus of claim 23, wherein the RRC message further comprises:
an indication of multiple transmit powers for control signal transmission, the multiple transmit powers including the increased transmit power, and
an indication of one or more A2N event thresholds each configured to trigger a corresponding transmit power of the multiple transmit powers.

25. The apparatus of claim 19, wherein the corrective signaling comprises a control signal configured to acknowledge that the retransmission of the first data signal was obtained, and wherein the control signal is multiplexed on, and obtained via a physical uplink shared channel (PUSCH).

26. The apparatus of claim 19, wherein the corrective signaling comprises a control signal indicating that the retransmission of the first data signal was obtained, and wherein the control signal is obtained via a physical uplink control channel (PUCCH).

27. The apparatus of claim 19, wherein the corrective signaling comprises a report indicative of the first A2N event, and wherein the report is obtained via a medium access control-control element (MAC-CE) or uplink control information (UCI) message.

28. The apparatus of claim 19, further comprising a transceiver configured to:
transmit the first data signal;
transmit the first signaling;
transmit the first data signal; and
receive the corrective signaling, wherein the apparatus is configured as a network entity.

29. A method for wireless communications at a wireless node, comprising:
outputting a first control signal configured to acknowledge that a first data signal was obtained, wherein the first control signal is output for transmission at a first transmit power;
obtaining, after outputting the first control signal, first signaling indicative of retransmission of the first data signal and further indicative of a first acknowledgment to negative acknowledgment (A2N) event; and
after obtaining the first signaling, outputting corrective signaling comprising at least one of: (i) a second control signal, wherein the second control signal is output for transmission at a second transmit power greater than the first transmit power based at least in part on the first A2N event, or (ii) a report indicative of the first A2N event.

30. The method of claim 29, wherein the first A2N event is one of multiple A2N events within a time window, and wherein the corrective signaling is output based on a quantity of the multiple A2N events satisfying a threshold condition.
